(19) United States
(12) Patent Application Publication
(10) Pub. No.: US 2026/0268925 A1
(43) Pub. Date: Sep. 10, 2026

(54) SITUATION DISPLAY APPARATUS, METHOD AND PROGRAM

(71) Applicant: NTT, Inc., Tokyo (JP)

(72) Inventors: Hiroko MUTO, Musashino-shi, Tokyo (JP); Takaaki FUKUTOMI, Musashino-shi, Tokyo (JP); Kenichi MORIMOTO, Musashino-shi, Tokyo (JP); Taichi ASAMI, Musashino-shi, Tokyo (JP); Hiroshi SATO, Musashino-shi, Tokyo (JP); Takafumi MORIYA, Musashino-shi, Tokyo (JP); Noboru MIYAZAKI, Musashino-shi, Tokyo (JP)

(73) Assignee: NTT, Inc., Tokyo (JP)

(21) Appl. No.: 19/126,663

(22) PCT Filed: Aug. 1, 2023
(86) PCT No.: PCT/JP2023/028072

§ 371 Date: May 2, 2025

(30) Foreign Application Priority Data
Nov. 2, 2022 (WO) PCT/JP2022/040953

(51) Int. Cl. G10L 25/48

(52) U.S. Cl. CPC G10L 25/48

(57) ABSTRACT

The situation display device includes a display unit that displays a picture showing a situation of an object person in each partial time section, which is a time section included in a predetermined time section, in association with the partial time section, in the vicinity of a two-dimensional graph showing the utterance amount of the object person per unit time in the predetermined time section, with one person who is an object of situation display as the object person.

### TECHNICAL FIELD

The technique disclosed herein relates to a technique for displaying a situation of an object person.

### BACKGROUND ART

A technique for displaying a two-dimensional graph regarding an utterance amount of an object person and a time axis is described in, for example, FIG. 7 of Patent Literature 1. The technique of Patent Literature 1 is for grasping a detailed situation in a conference. FIG. 7 of Patent Literature 1 is for grasping an utterance amount of each participant of the conference.

Patent Literature 2 discloses a technique for estimating and displaying a theme of a conversation and the content thereof on the basis of the content of utterances of a plurality of persons. The technique of Patent Literature 2 is for grasping a detailed situation in a conference similarly to the technique of Patent Literature 1. The technique specifically described in Patent Literature 2 is a technique for estimating a theme for each partial section of a conversation among a plurality of persons.

### CITATION LIST

### Patent Literature

Patent Literature 1: JP 2004-350134 A

Patent Literature 2: JP 2017-009825 A

### SUMMARY OF INVENTION

### Technical Problem

Since both Patent Literature 1 and Patent Literature 2 are for grasping a detailed situation in a conference, the situation in which an object person is placed in Patent Literature 1 or Patent Literature 2 is naturally “joining a conference”. In Patent Literature 1 and Patent Literature 2, although a detailed situation in a conference can be grasped, it is not assumed to estimate or visualize a situation in which an object person who has uttered is placed.

Patent Literature 2 discloses a technique for estimating and displaying a theme of a conversation and the content thereof on the basis of the content of utterances of a plurality of persons. However, it is not assumed in Patent Literature 2 to estimate or visualize a situation in which a certain person who has uttered is placed.

An object of the technique disclosed herein is to display a situation in which one object person is placed in an easy-to-understand manner.

### Solution to Problem

A situation display device according to one aspect of the disclosed technique includes a display unit that displays a diagram showing a situation of an object person in each partial time section, which is a time section included in a predetermined time section, in association with the partial time section, in the vicinity of a two-dimensional graph showing an utterance amount of the object person per unit time in the predetermined time section, with one person who is an object of situation display as the object person.

A situation display device according to one aspect of the disclosed technique includes a display unit that displays a visual expression showing at least one of a situation, a state, or an action of an object person in each partial time section, which is a time section included in a predetermined time section, in association with the partial time section, in the vicinity of a visualized totalization result indicating a situation of human activity obtained from a voice of the object person per unit time in the predetermined time section, with one person who is an object of situation display as the object person.

### Advantageous Effects of Invention

According to the disclosed technique, a situation in which a certain object person is placed can be displayed in an easy-to-understand manner.

### BRIEF DESCRIPTION OF DRAWINGS

FIG. 1 is a diagram illustrating an example of a functional configuration of a situation display device.

FIG. 2 is a diagram illustrating an example of a processing procedure of a situation display method.

FIG. 3 is a diagram illustrating a functional configuration example of a device in which the situation display device is implemented.

FIG. 4 is a diagram illustrating an example of a functional configuration of a model generation device.

FIG. 5 is a diagram illustrating an example of display.

FIG. 6 is a diagram illustrating an example of display.

FIG. 7 is a diagram illustrating a functional configuration example of a computer.

### DESCRIPTION OF EMBODIMENTS

Hereinafter, an embodiment of the disclosed technique will be described with reference to the drawings. Note that, in the drawings, components having the same functions are denoted by the same reference numerals, and redundant description will be omitted.

### Situation Display Device and Method

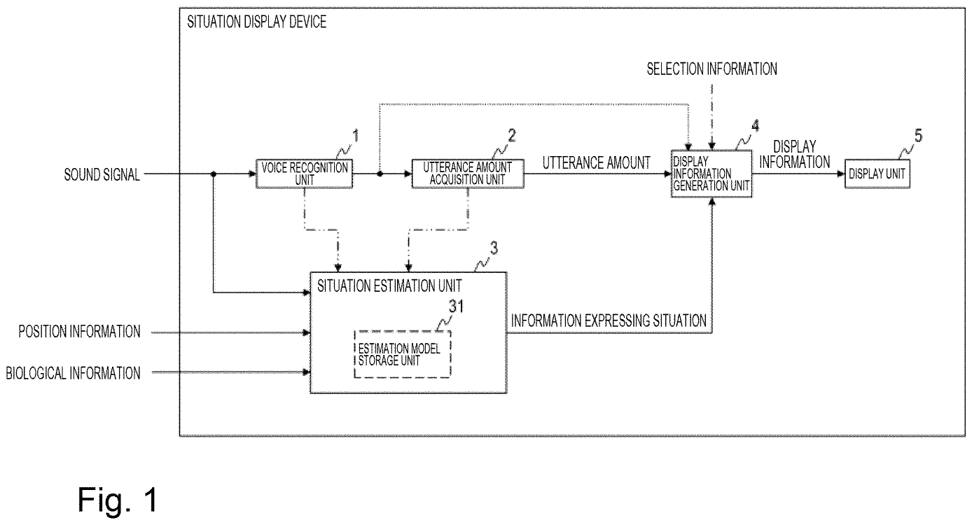

As illustrated in FIG. 1, the situation display device includes, for example, a voice recognition unit 1, an utterance amount acquisition unit 2, a situation estimation unit 3, a display information generation unit 4, and a display unit 5.

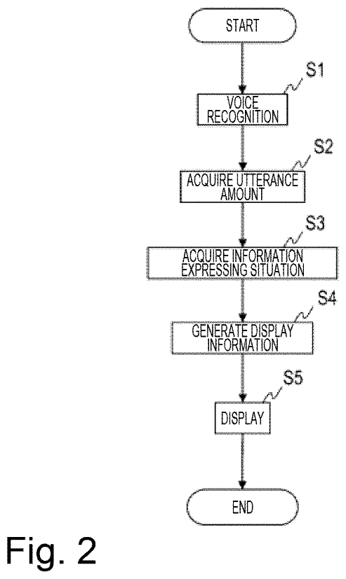

The situation display method is implemented, for example, by each component of the situation display device performing the processing of steps S1 to S5 illustrated in FIG. 2.

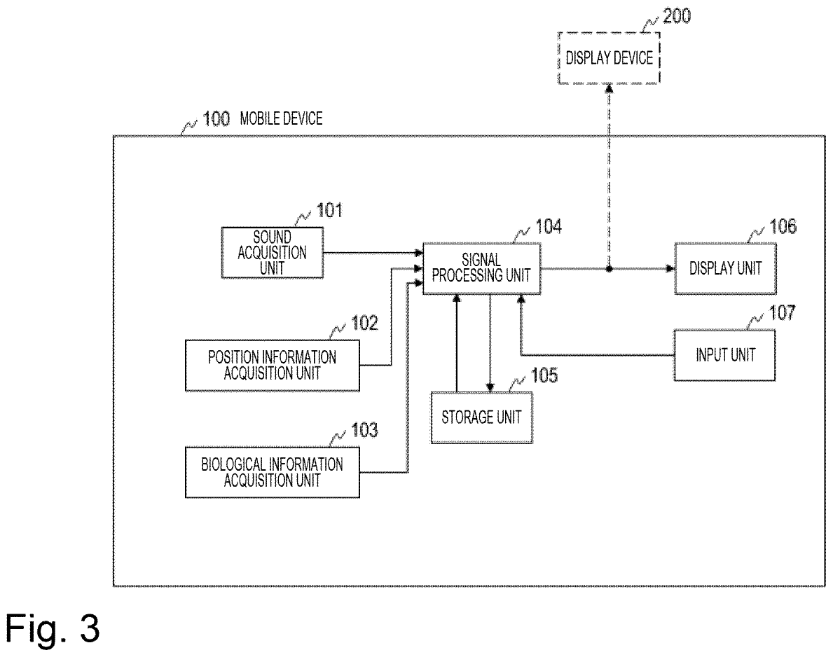

The situation display device is, for example, a device included in a smartphone, a phablet, a tablet, a smart watch, a mobile phone, a PDA, a portable game machine, or the like. In particular, as in a mobile device 100 illustrated in FIG. 3, a device including a situation display device is preferably a device that is movable together with the object person of situation display (which will be hereinafter referred to as an “object person”) and includes a sensor that acquires not only sound or position information but also biological information of the object person. An example of the mobile device 100 is a smart watch. For example, when the object person wears the mobile device 100, the mobile device 100 becomes movable together with the object person.

As illustrated in FIG. 3, the mobile device 100 includes a sound acquisition unit 101, a position information acquisition unit 102, a biological information acquisition unit 103, a signal processing unit 104, a storage unit 105, a display unit 106, and an input unit 107.

The sound acquisition unit 101 includes, for example, a microphone and an AD converter. The sound acquisition unit 101 collects a sound generated in a surrounding space with a microphone, and outputs a digital sound signal obtained by AD conversion of the collected sound with the AD converter to the signal processing unit 104.

The position information acquisition unit 102 includes, for example, a GPS antenna and a GPS module. The position information acquisition unit 102 outputs position information for specifying the position of the mobile device 100 to the signal processing unit 104.

The biological information acquisition unit 103 includes, for example, a biological information sensor and a biological information output module. The biological information acquisition unit 103 outputs biological information for specifying information regarding the living body of the object person wearing the mobile device 100 to the signal processing unit 104. The biological information is physiological information or anatomical information of the object person, such as the heart rate, the blood pressure, the body temperature, electrocardiographic information, and the amount of perspiration. Note that an acceleration sensor may function as the biological information acquisition unit 103. That is, the biological information may include acceleration measured by the biological information acquisition unit 103 that is also an acceleration sensor, the activity amount of the object person estimated from the acceleration, and the like.

The sound signal, the position information, and the biological information are sensor information acquired by a sensor (the sound acquisition unit 101, the position information acquisition unit 102, and the biological information acquisition unit 103) included in the mobile device 100.

The signal processing unit 104 is, for example, a central processing unit (CPU). The signal processing unit 104 generates display information from the inputted sound signal, position information, and biological information, and outputs the display information to the display unit 106.

The storage unit 105 is a main storage device such as a random access memory (RAM), for example.

The display unit 106 is a display device having a screen such as a liquid crystal display (LCD) or an organic EL display (OLED), for example. The display unit 106 makes display based on the inputted display information. The display unit 106 is also a display unit 5 to be described later.

Note that a display device 200 indicated by broken lines in FIG. 3 may be provided outside the mobile device 100. The display device 200 is a display device having a screen such as a liquid crystal display (LCD) or an organic EL display (OLED), for example. In this case, the signal processing unit 104 may output the display information to the display device 200. In this case, the display device 200 makes display based on the inputted display information.

The input unit 107 is an input device such as a touch panel, or a pointing device such as a mouse and a track ball. Selection information to be described later is generated when the user performs an input operation using the input unit 107. The generated selection information is inputted to the signal processing unit 104.

Note that the display unit 106 and the input unit 107 may be the same hardware such as a touch screen.

Note that, even in a case where some of the components of the mobile device 100 are connected by communication such as Bluetooth (registered trademark) and provided in another device physically separated from the mobile device 100, some of the components of the mobile device 100 are included in the mobile device 100.

The sound signal outputted by the sound acquisition unit 101, the position information outputted by the position information acquisition unit 102, and the biological information outputted by the biological information acquisition unit 103 are inputted to cause the signal processing unit 104, the display unit 106, the input unit 107, and the like to perform processing of each component (the voice recognition unit 1, the utterance amount acquisition unit 2, the situation estimation unit 3, the display information generation unit 4, and the display unit 5) of the situation display device, so that the situation display device is implemented on the mobile device 100.

Hereinafter, the processing of each component of the situation display device will be described.

### Voice Recognition Unit 1

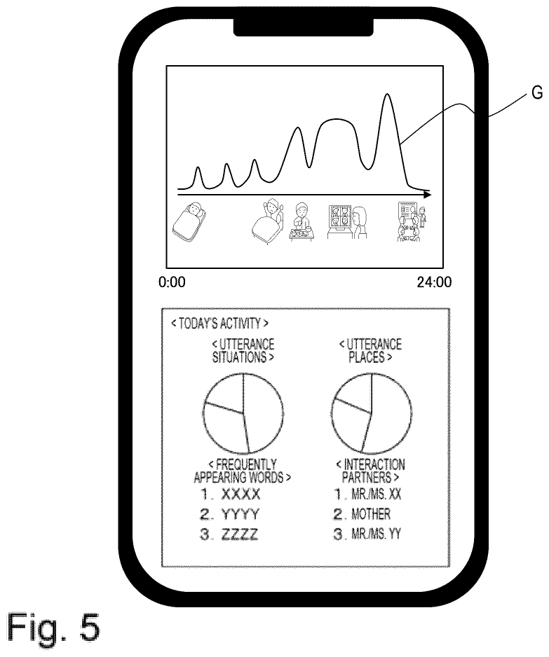

A sound signal in a predetermined time section, which is a time section to be an object of display of the situation of the object person, is inputted to the voice recognition unit 1. For example, in the case of displaying a daily situation of the object person as illustrated in FIG. 5, the predetermined time section is 24 hours from 0:00 to 24:00 of the day.

The voice recognition unit 1 obtains a voice recognition result by performing voice recognition processing on the inputted sound signal.

The obtained voice recognition result is outputted to the utterance amount acquisition unit 2. The obtained voice recognition result may be outputted to the situation estimation unit 3 and the display information generation unit 4 as necessary.

Since the voice recognition result outputted to the utterance amount acquisition unit 2 is used by the utterance amount acquisition unit 2 to acquire the utterance amount of the object person as described later, the voice recognition result is a voice recognition result of the object person, and is, for example, a result in which the voice of the object person is expressed by a string of characters, phonemes, or the like. Since the sound signal inputted to the voice recognition unit 1 includes a sound generated in a surrounding space of the microphone, the sound signal inputted to the voice recognition unit 1 may include a voice signal of a voice uttered by a person other than the object person.

Accordingly, the voice recognition unit 1 obtains a voice recognition result for a voice signal of the object person included in the inputted sound signal using a recognition technique for obtaining a voice recognition result of a specific speaker (step S1).

Since what the utterance amount acquisition unit 2 acquires is the utterance amount per unit time, the voice recognition result is preferably inputted to the utterance amount acquisition unit 2 in association with a time when the voice that is the source of the voice recognition result is uttered, that is, in association with a time when the sound acquisition unit 101 acquires the sound. For this purpose, for example, the mobile device 100 may include a built-in clock (not illustrated), or the GPS module of the position information acquisition unit 102 may acquire time so that the sound signal outputted from the sound acquisition unit 101 is associated with the time, and the voice recognition result outputted from the voice recognition unit 1 and time may be associated with each other using the time. Note that the time used in each component to be described later may be similarly acquired from, for example, a built-in clock or a GPS module.

### Utterance Amount Acquisition Unit 2

The utterance amount acquisition unit 2 receives as input the voice recognition result of the object person in the predetermined time section obtained by the voice recognition unit 1.

The utterance amount acquisition unit 2 acquires the utterance amount of the object person per unit time in the predetermined time section using the voice recognition result of the object person in the predetermined time section (step S2).

The acquired utterance amount of the object person per unit time is outputted to the display information generation unit 4 in association with a representative time of each unit time. The acquired utterance amount of the object person per unit time and the acquired representative time of each unit time may be outputted to the situation estimation unit 3 as necessary.

Examples of the representative time of the unit time include a time at a predetermined point included in the unit time, such as a central time of the unit time, a start time of the unit time, and an end time of the unit time.

Examples of the utterance amount include the number of words, the number of words of a specific part of speech, the number of characters, the number of phonemes, and the like, for example. A specific part of speech is a part of speech other than a postpositional particle and an auxiliary verb, for example, a noun, a verb, an adjective, an adverb, or the like.

In a case where the number of words, the number of words of a specific part of speech, or the like is set as the utterance amount, the utterance amount acquisition unit 2 performs, for example, processing such as morphological analysis on the voice recognition result, and performs processing of acquiring the utterance amount using the result of the morphological analysis processing.

The unit time is a time preset according to how to display a two-dimensional graph to be described later.

### Situation Estimation Unit 3

The situation estimation unit 3 estimates a situation in which the object person is placed. The situation in which the object person is placed can be estimated from, for example, information sensed from the object person, such as a voice of the object person, an utterance of the object person, the position of the object person, a biological state of the object person, a sound made in the surroundings of the object person, a voice of an interaction partner of the object person, an utterance of an interaction partner of the object person, and/or information sensed from the surroundings of the object person. Thus, the situation estimation unit 3 estimates the situation in which the object person is placed from the information sensed from the object person and/or the information sensed from the surroundings of the object person.

For example, a voice of the object person, an utterance of the object person, a sound made in the surroundings of the object person, a voice of an interaction partner of the object person, or an utterance of an interaction partner of the object person is included in a sound signal that is sensor information acquired by the sound acquisition unit 101 that is one of sensors provided in the mobile device 100. Accordingly, the sound signal acquired by the sound acquisition unit 101 of the mobile device 100 and inputted to the situation estimation device may be inputted to the situation estimation unit 3. Note that the voice recognition result obtained by the voice recognition unit 1 and the utterance amount acquired by the utterance amount acquisition unit 2 are part of information on the utterance of the object person.

Accordingly, as indicated by two-dot chain lines in FIG. 1, at least one of the voice recognition result obtained by the voice recognition unit 1 or the utterance amount acquired by the utterance amount acquisition unit 2 may be inputted to the situation estimation unit 3. In the situation estimation unit 3, the voice recognition result obtained by the voice recognition unit 1 and the utterance amount acquired by the utterance amount acquisition unit 2 are also treated as sensor information, similarly to other sensor information.

For example, the position of the object person is the position of the mobile device 100 that moves together with the object person. Accordingly, the position information acquired by the position information acquisition unit 102 of the mobile device 100 and inputted to the situation estimation device may be inputted to the situation estimation unit 3.

For example, the biological state of the object person can be acquired by the mobile device 100 worn by the object person. Accordingly, the biological information acquired by the biological information acquisition unit 103 of the mobile device 100 and inputted to the situation estimation device may be inputted to the situation estimation unit 3.

That is, the sensor information acquired by at least one sensor included in the mobile device 100 that has acquired the sound signal that is the acquisition source of the utterance amount of the object person and inputted to the situation estimation device may be inputted to the situation estimation unit 3.

The situation estimation unit 3 acquires information expressing the situation of the object person for each partial time section, which is a time section in which the object person is in the same situation in the predetermined time section, using information sensed from the object person and/or information sensed from the surroundings of the object person, specifically, sensor information acquired by the mobile device 100 worn by the object person (step S3).

The information expressing the situation of the object person in each partial time section is outputted to the display information generation unit 4 in association with the representative time of each partial time section.

The information expressing the situation of the object person is a picture showing the situation of the object person. However, the information expressing the situation of the object person may also include information other than a picture. That is, the information expressing the situation of the object person may include a symbol indicating the situation of the object person, a number indicating the situation of the object person, a character string indicating the situation of the object person, an identifier indicating the situation of the object person, and the like in addition to a picture showing the situation of the object person.

Examples of the representative time of a partial time section are times at predetermined positions included in the partial time section, such as a central time of the partial time section, a start time of the partial time section, and an end time of the partial time section.

For example, the situation estimation unit 3 may estimate, for a predetermined time section, information expressing the situation of the object person in each unit time section (which will be hereinafter referred to as an “estimation unit time section”) to be an object of estimation of the situation (step S3-1), specify consecutive time sections having the same information expressing the situation of the object person as partial time sections, which are time sections in which the object person is in the same situation (step S3-2), acquire information expressing the situation of the object person in each partial time section (step S3-3), and acquire representative time of each partial time section (step S3-4).

For example, as the processing of step S3-1, the situation estimation unit 3 performs processing of estimating, with the sensor information as an input, a most likely candidate from among a plurality of preset candidates for information expressing the situation of a person as information expressing the situation of the object person using an estimation model read from an estimation model storage unit 31 included in the situation estimation unit 3

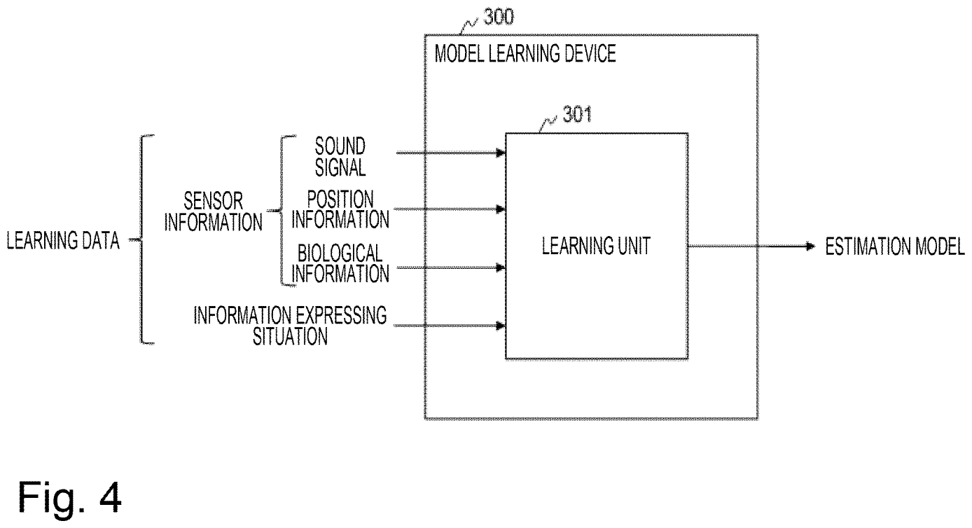

The estimation model stored in the estimation model storage unit 31 is an estimation model learned in advance by the model learning device 300 illustrated in FIG. 4, for example, before processing by the situation display device and the method is performed.

As illustrated in FIG. 4, the model learning device 300 includes a learning unit 301. Learning data is inputted to the learning unit 301. J is a positive integer, j is expressed as j=1, . . . , J, a set (A(j), B(j)) of information sensed from an object person (which will be hereinafter referred to as a “learning object person”) at the time of learning and/or information sensed from the surroundings of the learning object person, specifically, sensor information A(j) acquired by the mobile device 100 worn by the learning object person and information B(j) expressing the situation of the learning object person corresponding to the sensor information A(j) is expressed as S(j), and the learning data is expressed as S(1), . . . , S(J). The sensor information is, for example, at least one of a sound signal acquired by the sound acquisition unit 101 of the mobile device 100 worn by the learning object person, position information acquired by the position information acquisition unit 102 of the mobile device 100 worn by the learning object person, and biological information of the learning object person acquired by the biological information acquisition unit 103 of the mobile device 100 worn by the learning object person.

The learning unit 301 learns an estimation model obtained using the inputted learning data and setting information expressing the most appropriate situation as the situation of a person corresponding to the inputted sensor information as information expressing the situation of the person corresponding to the inputted sensor information. The learned estimation model is stored in the estimation model storage unit 31 indicated by broken lines in FIG. 1. A known learning technique may be used for learning the estimation model. The amount of learning data may be an amount sufficient for learning the estimation model. Note that, if the estimation model is learned with learning data in which many people are set as the learning object persons, estimation can be performed with a certain degree of accuracy for various object persons, and if the estimation model is learned with learning data in which a specific person is set as the learning object person, the estimation accuracy of the case where the specific person is set as the object person can be made extremely high, and therefore, the learning data may be appropriately prepared according to an assumed use situation of the situation display device and the method.

Note that the type of information included in the sensor information used in the learning stage and the type of information included in the sensor information used in the estimation stage are preferably the same. For example, in a case where the learning unit 301 has performed learning using the sensor information regarding a learning object person including all of the sound signal acquired by the sensor worn by the learning object person, the position information of the learning object person, and the biological information of the learning object person, the situation estimation unit 3 uses the sensor information for the estimation object person including all of the sound signal acquired by the sensor worn by the estimation object person, the position information of the estimation object person, and the biological information of the estimation object person.

For example, there is a high possibility that the object person is sleeping in a case where the utterance amount of the object person acquired from the sound signal included in the sensor information is smaller than a predetermined utterance amount, the biological information included in the sensor information indicates a tendency that the object person is sleeping, and the position information included in the sensor information indicates that the object person is at home for a long time.

Moreover, for example, there is a high possibility that the situation of the object person is exercising in a case where the biological information included in the sensor information indicates a tendency that the object person is exercising, the position information included in the sensor information indicates that the object person is in a predetermined place where the object person usually exercises, such as a sports gym, and it can be determined from the sound signal included in the sensor information that the object person is speaking about a content related to exercise with a predetermined person with whom the object person is involved during exercise, such as an instructor. Whether the object person shows a tendency to be exercising or not can be estimated from, for example, the acceleration, the heart rate, the amount of perspiration, and the like in the biological information included in the sensor information.

Moreover, for example, there is a high possibility that the situation of the object person is joining a conference in a case where it can be determined from the sound signal included in the sensor information that the object person is interacting with a predetermined related person in the conference and the object person is speaking about a predetermined content to be discussed in a conference, and the sound signal position information included in the sensor information indicates that the object person is in a company.

Moreover, for example, there is a high possibility that the situation of the object person is moving in a case where the size of the sound signal included in the sensor information is equal to or larger than a predetermined size, and the position information included in the sensor information indicates that the object person is moving outdoors.

Moreover, for example, there is a high possibility that the situation of the object person is having a meal in a case where the position information included in the sensor information indicates that the object person is at a predetermined place where a meal is to be provided for a certain period of time, and the utterance amount included in the sensor information indicates a tendency that the object person is having a meal. Whether the object person shows a tendency to be having a meal or not can be estimated from, for example, the utterance content obtained from a sound signal included in the sensor information, an utterance partner, and the like.

Moreover, there is a high possibility that the situation of the object person is talking to himself/herself in a case where the sound signal included in the sensor information indicates that the object person is uttering while the object person does not have an interaction partner.

As can be seen from the above examples, the situation estimation unit 3 can estimate, as information expressing the situation of the object person, the most likely candidate from above candidates of information expressing a preset human situation using sensor information input regarding the object person including all of the sound signal acquired by the sensor worn by the object person for situation estimation, the position information of the object person, and the biological information of the object person, when using an estimation model learned using, as the learning data, a set of the sensor information regarding the learning object person and the situation of the learning object person including all of the sound signal acquired by the sensor worn by the learning object person, the position information of the learning object person, and the biological information of the learning object person.

Note that, as can be seen from the specific examples of each situation described above, in a case where the object person is wearing the mobile device 100, the situation estimation unit 3 can estimate the situation of the object person with high accuracy by using the sensor information acquired by another sensor included in the mobile device 100 including the sound acquisition unit 101 that acquires the sound signal serving as the acquisition source of the utterance amount of the object person in the utterance amount acquisition unit 2, specifically, by using the sensor information acquired by the position information acquisition unit 102 or the biological information acquisition unit 103 included in the mobile device 100.

Accordingly, in the situation display device and the method, a sound acquired by the microphone included in the mobile device 100 worn by the object person is subjected to voice recognition so that the utterance amount of the object person is obtained, and the situation of the object person is preferably obtained from the sensor information acquired by one or more sensors other than the microphone included in the mobile device 100 worn by the object person.

Moreover, as can be seen from the specific examples of each situation described above, the situation estimation unit 3 can estimate the situation of the object person with high accuracy if the position information of the object person can be used. Accordingly, the sensor used for the situation of the object person preferably includes a sensor that acquires position information included in the mobile device 100 worn by the object person.

Between the processing of step S3-1 and the processing of step S3-2, the situation estimation unit 3 may perform processing of correcting the information expressing the situation of the object person obtained in step S3-1 using the information expressing the situation of the object person obtained in step S3-1 in an adjacent estimation unit time section for each estimation unit time section included in the predetermined time section (step S3-1.1). For example, the situation estimation unit 3 may set each estimation unit time section included in the predetermined time section as a “processing object section”, set information expressing the situation of the object person as “object person situation information” for convenience, set K as a positive integer, set L as a positive integer, set M as a positive integer, set N as a positive integer, and perform the following processing of step S3-1.1A or processing of step S3-1.1B as the processing of step S3-1.1.

Step S3-1.1A: For each processing object section, the situation estimation unit 3 sets, as object person situation information of the processing object section, object person situation information with the highest frequency among the object person situation information obtained in step S3-1 of the processing object section, the object person situation information obtained in step S3-1 of consecutive K estimation unit time sections immediately before the processing object section, and the object person situation information obtained in step S3-1 of consecutive L estimation unit time sections immediately after the processing object section. Note that, although K and L are preferably the same value, K may be set to a value smaller than L in a case where the processing object section is near the start of the predetermined time section, L may be set to a value smaller than K in a case where the processing object section is near the end of the predetermined time section, K may be set to 0 exceptionally in a case where the processing object section is at the start of the predetermined time section, or L may be set to 0 exceptionally in a case where the processing object section is at the end of the predetermined time section, so that the processing in step S3-1.1A is completed only by the information in the predetermined time section.

Step S3-1.1B: For each processing object section, in a case where all of the object person situation information obtained in step S3-1 of M consecutive estimation unit time sections immediately before the processing object section, and object person situation information obtained in step S3-1 of the N consecutive estimation unit time sections immediately after the processing object section are the same, the situation estimation unit 3 sets the same object situation information (i.e., the object person situation information obtained in step S3-1 of the M consecutive estimation unit time sections immediately before the processing object section and the N consecutive estimation unit time sections immediately after the processing object section) as the object person situation information of the processing object section. Note that, although M and N are preferably the same value, M may be set to a value smaller than N in a case where the processing object section is near the start of the predetermined time section, N may be set to a value smaller than M in a case where the processing object section is near the end of the predetermined time section, M may be set to 0 exceptionally in a case where the processing object section is at the start of the predetermined time section, or N may be set to 0 exceptionally in a case where the processing object section is at the end of the predetermined time section, so that the processing in step S3-1.1B is completed only by the information in the predetermined time section.

If the situation estimation unit 3 performs processing of estimating the object person situation information using the estimation model as the processing of step S3-1, there is a possibility that an estimation error occurs at a low frequency, though the object person situation information of each estimation unit time section can be accurately estimated. The processing in step S3-1.1 is to correct the estimation error by using the fact that the human situation is less likely to change to various situations in a short time.

### Display Information Generation Unit 4

The display information generation unit 4 receives as input the utterance amount of the object person per unit time acquired by the utterance amount acquisition unit 2 and the representative time of each unit time. Moreover, the display information generation unit 4 receives as input information expressing the situation of the object person in each partial time section estimated by the situation estimation unit 3 and the representative time of each partial time section.

The display information generation unit 4 generates display information, which is information to be displayed on the display unit 5, by using the utterance amount of the object person per unit time, the representative time of each unit time, information regarding the situation of the object person in each partial time section, and the representative time of each partial time section (step S4).

The generated display information is outputted to the display unit 5. As described later, the display unit 5 makes display based on the display information.

### First Example of Display Information Generation Unit 4

The display information generation unit 4 generates a two-dimensional graph showing the utterance amount of the object person per unit time in the predetermined time section by using the utterance amount of the object person per unit time and the representative time of each unit time, and generates display information that is an image for displaying a picture showing the situation of the object person in each partial time section, which is a time section included in the predetermined time section, on the display unit 5 in association with the partial time section, in the vicinity of the generated two-dimensional graph by using information expressing the situation of the object person in each partial time section and the representative time of each partial time section.

Hereinafter, an example of a screen of the display unit 5 displayed on the basis of the first example of the display information generated by the display information generation unit 4 will be described with reference to FIG. 5.

In the example in FIG. 5, a two-dimensional graph G showing the utterance amount of the object person per unit time in the predetermined time section is illustrated in an upper portion of the screen of the display unit 5. In the example in FIG. 5, the predetermined time section is 24 hours from 0:00 to 24:00. The horizontal axis of the two-dimensional graph G is a time axis, and the vertical axis of the two-dimensional graph G indicates an utterance amount of the object person per unit time. Moreover, in the example in FIG. 5, a picture showing the situation of the object person in each partial time section, which is a time section included in the predetermined time section, is illustrated below the two-dimensional graph G. However, the position of the picture showing the situation of the object person is not necessarily below the two-dimensional graph G.

That is, in the display information which is an image to be displayed on the display unit 5, the two-dimensional graph showing the utterance amount of the object person per unit time in the predetermined time section is a graph in which the horizontal axis is the time axis, the vertical axis is the axis of the utterance amount, and utterance amounts of the object person per unit time are connected by a straight line or a curve line.

Then, in the display information that is an image to be displayed on the display unit 5, a picture showing the situation of the object person is arranged at the position of the representative time on the time axis of the two-dimensional graph, above or below the time axis of the two-dimensional graph, or above or below a straight line or a curve line expressing the utterance amount of the two-dimensional graph.

In this manner, it is possible to display the situation in which an object person to be an object of situation display is placed in an easy-to-understand manner by displaying the picture showing the situation of the object person in each partial time section in the vicinity of the two-dimensional graph showing the utterance amount of the object person to be an object of situation display.

### Second Example of Display Information Generation Unit 4

Although the display information generation unit 4 generates display information similar to that of the first example, the display information generation unit 4 may generate display information for displaying a smaller number of pictures as the display area in the screen of the display unit 5 is smaller. That is, the display information generation unit 4 may select some of the inputted pictures showing the situation of the object person and include the selected pictures in the display information, instead of displaying all of the inputted pictures showing the situation of the object person. For example, the display information generation unit 4 may select a preset number of pictures corresponding to the size of the display area of the screen of the display unit 5 from among the inputted pictures showing the situation of the object person and include the selected pictures in the display information, or may select pictures according to a preset selection criterion corresponding to the size of the display area of the screen of the display unit 5 and include the selected pictures in the display information.

For example, the display information generation unit 4 may preferentially include, in the display information, a picture having a longer corresponding partial time section among the inputted pictures showing the situation of the object person. Specifically, the display information generation unit 4 may select a preset number of pictures corresponding to the size of the display area of the screen of the display unit 5 in descending order of length of the corresponding partial time section among the inputted pictures showing the situation of the object person, and include the selected pictures in the display information.

Moreover, for example, the display information generation unit 4 may preferentially include, in the display information, a time section with a larger utterance amount in an inputted picture showing the situation of the object person. Specifically, the display information generation unit 4 may select a preset number of pictures corresponding to the size of the display area of the screen of the display unit 5 in descending order of the utterance amount in the corresponding partial time section from among the inputted pictures showing the situation of the object person, and include the selected pictures in the display information.

### Third Example of Display Information Generation Unit 4

As in the example in FIG. 5, the first example or the second example may be displayed in an upper portion of the screen of the display unit 5, and the statistical information on the situation of the object person in the predetermined time section may be displayed in a lower portion of the screen of the display unit 5. In the example in FIG. 5, utterance situations, utterance places, frequently appearing words, and interaction partners are displayed as the statistical information of the situation of the object person in 24 hours, which is the predetermined time section corresponding to the two-dimensional graph G, in a column with a title of <Today's activity>.

The utterance situation is a situation of the object person. In the example in FIG. 5, the utterance situation is expressed by a circular graph. Examples of the display information regarding the utterance situation include a picture or a character expressing each situation in which the object person made utterance, a time of each situation, and a ratio (e.g., joining a conference: 82 minutes (47%), exercising: 55 minutes (31%), having a meal: 35 minutes (20%) ) of each situation to the entire situation in which the object person made utterance. Note that the ratio of the situation of the object person to the predetermined time section may be used as the display information regarding the utterance situation.

The utterance place is a place where the object person has made utterance. In the example in FIG. 5, the utterance place is expressed by a circular graph. Examples of the display information regarding the utterance place include the place where the object person made utterance, the time when the object person was at the place where the object person made utterance, and the ratio (e.g., company: 125 minutes (52%), home: 63 minutes (26%), around Shibuya: 43 minutes (18%) ) of each place where the object person made utterance to the time when the object person made utterance. Note that the ratio of the place where the object person made utterance or the place where the object person was to the predetermined time section may be used as the display information regarding the utterance place.

Note that, in a case where the utterance place is displayed, for example, the situation estimation unit 3 may estimate the utterance place of the object person together with the information expressing the situation of the object person, the estimation result may be inputted to the display information generation unit 4, and the display information generation unit 4 may use the inputted utterance place.

The frequently appearing word is a word frequently used by the object person in the predetermined time section. In the example in FIG. 5, top three words frequently used by the object person in the predetermined time section are displayed as the frequently appearing words.

The interaction partner is a person who has made interaction with the object person. In the example in FIG. 5, top three persons with a large number of times of interaction made by the object person are displayed as the interaction partners.

Note that, for example, the voice recognition unit 1 may perform voice recognition processing for specifying the utterance content and the speaker, and the result of the voice recognition processing may be inputted to the display information generation unit 4 as indicated by dotted lines in FIG. 1, so that the frequently appearing word and the interaction partner are determined from the inputted voice recognition result by the display information generation unit 4. Note that, in a case where the situation display device is the mobile device 100 that can make a call, the display information generation unit 4 may acquire information on the interaction partner by also using the past call history stored in the mobile device 100.

As in the example in FIG. 5, the statistical information on the situation of the object person may be shown by a graph displaying a ratio, such as a circular graph. Moreover, the statistical information on the situation of the object person may be ranked and shown. As a result, the situation in which the object person is placed can be displayed in an easier-to-understand manner.

### Fourth Example of Display Information Generation Unit 4

A picture showing the situation of the object person or the statistical information on the situation of the object person is selectable, and when the picture showing the situation of the object person or the statistical information on the situation of the object person is selected, the display may be switched to a display of information regarding the situation of the object person corresponding to the selected picture or statistical information.

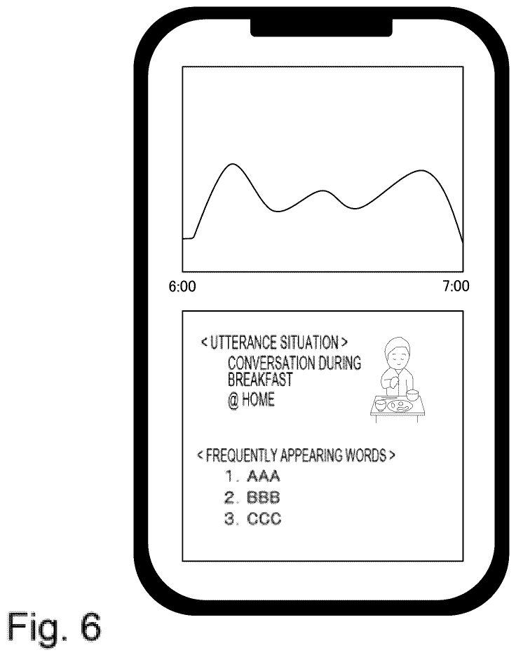

For example, when the picture showing the situation of the object person in FIG. 5 (more specifically, the picture showing the situation of having breakfast in the picture showing the situation of the object person in FIG. 5) or the statistical information of the situation of the object person in FIG. 5 (more specifically, a part of the situation of having breakfast in the circular graph in the statistical information of the situation of the object person in FIG. 5) is selected, the display is switched to a display of information regarding the situation of having breakfast, which is the situation of the object person corresponding to the selected picture or statistical information, illustrated in FIG. 6.

In FIG. 6, the utterance amount of the object person per unit time of the object person in the partial time section corresponding to the situation of having breakfast, the utterance situation in the situation of having breakfast, and the frequently appearing words in the situation of having breakfast are displayed as the information regarding the situation of the object person corresponding to the situation of having breakfast.

The example in FIG. 6 is an example in which the partial time section corresponding to the situation of having breakfast is from 6:00 to 7:00, and the utterance amount of the object person per unit time of the object person in the partial time section from 6:00 to 7:00 is displayed. Moreover, in the example in FIG. 6, “conversation during breakfast @ home” is displayed as the utterance situation in the situation of having breakfast. Note that “conversation during breakfast @ home” means that the utterance in the situation of having breakfast is the conversation during breakfast at home. Moreover, in the example in FIG. 6, the top three words frequently used by the object person in the situation of having breakfast are displayed as frequently appearing words in the situation of having breakfast.

That is, a plurality of displayed pictures showing the situation of the object person is selectable, and when any one of the plurality of pictures is selected, the display is switched to a display including at least information regarding the situation and the utterance of the object person in the partial time section corresponding to the selected picture. Moreover, in a case where a ratio display graph that is a graph showing the ratio occupied by the time during which the object person was in each situation is also displayed, an area of each ratio included in the ratio display graph is selectable, and when any one of the plurality of areas is selected, the display is switched to a display including at least information regarding the utterance of the object person of the object person in the situation corresponding to the selected area. Furthermore, in a case where a ratio display graph that is a graph showing a ratio occupied by the time during which the object person is at each position is also displayed, an area of each ratio included in the ratio display graph is selectable, and when any one of the plurality of areas is selected, the display is switched to a display including at least information regarding the utterance of the object person at the position corresponding to the selected area.

When the user performs a selection operation of selecting a picture showing the situation of the object person or statistical information of the situation of the object person, the input unit 107 accepts the selection operation and outputs selection information expressing the selection operation. The selection information outputted from the input unit 107 is inputted to the display information generation unit 4 as indicated by alternate long and short dash lines in FIG. 1. The display information generation unit 4 newly generates display information for displaying information regarding the situation of the object person corresponding to the selected picture or statistical information on the basis of the inputted selection information, and outputs the newly generated display information to the display unit 5, and the display unit 5 makes display based on the newly generated display information.

In this way, more detailed information corresponding to the selected picture showing the situation of the object person or the selected statistical information of the situation of the object person is shown, so that the situation in which the object person is placed can be more easily understood.

### Fifth Example of Display Information Generation Unit 4

In a case where the situation of the object person estimated by the situation estimation unit 3 is wrong, an error may occur in the picture showing the situation of the object person displayed in the vicinity of the two-dimensional graph explained in the first example and the second example, and the user who looks at the display of the display unit 5 may notice the error. In a case where the user notices an error in the displayed picture showing the situation of the object person, the user may select the picture showing the situation of the object person displayed on the display unit 5, so that can be corrected into a picture showing the correct situation of the object person. In this case, the situation estimation unit 3 may generate a new estimation model by operating the model learning device 300 using the correct picture showing the situation of the object person and the sensor information of the partial time section corresponding to the picture, and update the estimation model stored in the estimation model storage unit 31 to the newly generated estimation model. In this way, the situation of the object person can be estimated with higher accuracy by learning the correct correspondence.

### Display Unit 5

The display unit 5 receives as input the display information generated by the display information generation unit 4.

The display unit 5 is a display device having a screen such as a liquid crystal display (LCD) or an organic EL display (OLED), for example.

The display unit 5 makes display based on the display information. As a result, the display unit 5 displays a picture showing the situation of the object person in each partial time section, which is a time section included in the predetermined time section, in association with the partial time section at least in the vicinity of the two-dimensional graph showing the utterance amount of the object person per unit time in the predetermined time section (step S5).

An example of display by the display unit 5 has been described in the description about the processing of the display information generation unit 4, and thus, redundant description will be omitted here.

In this way, it is possible to display the situation in which one object person is placed in an easy-to-understand manner by displaying a picture showing the situation of the object person in each partial time section, which is a time section included in the predetermined time section, in the vicinity of the two-dimensional graph showing the utterance amount of the object person per unit time in the predetermined time section in association with the partial time section.

### Modification

The “utterance amount of the object person” in the display information generated by the display information generation unit 4 may be a “situation of human activity obtained from the voice of the object person”.

The situation of human activity is a superordinate concept of the utterance amount. Examples of the situation of human activity are the utterance amount, the loudness, the emotion, raising and lowering of intonation, the speed, change in tone, the length of uninterrupted talking time, the number of interruptions, and wording. The emotion is expressed by, for example, the degree of various types of emotions such as joy, anger, sadness, surprise, trust, expectation, and anxiety, the degree of emotions obtained by classifying these emotions into two types of positive and negative, or the like. Note that, in a case where a voice of the interaction partner is further obtained, the situation of the human activity may include the utterance amount, the loudness, and the emotion of the interaction partner. Moreover, the emotion may include a score indicating a depression symptom.

The score indicating a depression symptom can be obtained by, for example, the techniques described in Reference Literatures 1 to 3. For example, a score indicating a depression symptom based on potentially linguistic information can be obtained by diverting a part of a deep learning model in the task of voice recognition (e.g., refer to Reference Literature 3).
[Reference Literature 1] S. Alghowinem, R. Goecke, M. Wagner, J. Epps, M. Breakspear and G. Parker, “Detecting depression: A comparison between spontaneous and read speech,” Proc. ICASSP 2013, pp. 7547-7551.
[Reference Literature 2] Huang, Z., Epps, J., Joachim, D., Stasak, B., Williamson, J. R., Quatieri, T. F., “Domain Adaptation for Enhancing Speech-Based Depression Detection in Natural Environmental Conditions Using Dilated CNNs,” Proc. Interspeech 2020, 4561-4565.
[Reference Literature 3] A. Harati, E. Shriberg, T. Rutowski, P. Chlebek, Y. Lu and R. Oliveira, “Speech-Based Depression Prediction Using Encoder-Weight-Only Transfer Learning and a Large Corpus, ” Proc. ICASSP 2021, 7273-7277.

The “two-dimensional graph” in the display information generated by the display information generation unit 4 may be a “visualized totalization result”.

The visualized totalization result is a superordinate concept of the two-dimensional graph. Examples of the visualized totalization result are a two-dimensional graph, a three-dimensional graph, ranking, a ratio graph, and a circular graph.

The “picture showing the situation of the object person” in the display information generated by the display information generation unit 4 may be “visual expression showing at least one of the situation, the state, or the action of the object person”.

The visual expression showing at least one of the situation, the state, or the action of the object person is a superordinate concept of a picture showing the situation of the object person. Examples of visual expression are a picture, an illustration, a photograph, an image, a video, a symbol, and an icon.

### Program, Recording Medium, etc.

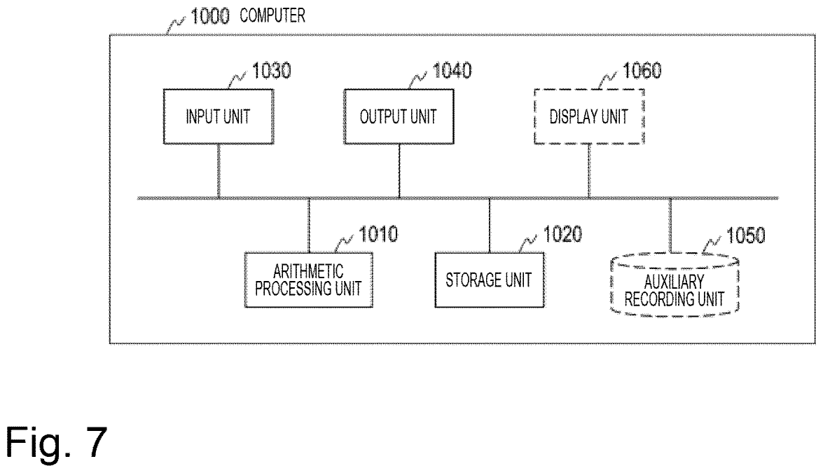

The processing of each unit of the situation display device described above may be implemented by a computer, and in this case, the processing content of the function that the situation display device should have is described in a program. Then, by causing a storage unit 1020 of a computer 1000 illustrated in FIG. 7 to read this program and causing an arithmetic processing unit 1010, an input unit 1030, an output unit 1040, a display unit 1060, and the like to operate, various processing functions in the situation display device are implemented on the computer.

The situation display device described above includes, for example, as a single hardware entity, an input unit to which a signal can be inputted from the outside of the hardware entity, an output unit from which a signal can be outputted to the outside of the hardware entity, a communication unit that can be connected with a communication device (e. g., a communication cable) capable of communicating with the outside of the hardware entity, a central processing unit (CPU, which may include a cache memory, a register, and the like) which is an arithmetic processing unit, a random access memory (RAM) and a read only memory (ROM) which are memories, an external storage device which is a hard disk, and a bus that makes connection such that the input unit, the output unit, the communication unit, the CPU, the RAM, the ROM, and the external storage device can exchange data. Moreover, a device (a drive) or the like that can read and write data in and from a recording medium such as a CD-ROM may be provided in the hardware entity as necessary. Examples of a physical entity including such a hardware resource include a general-purpose computer.

The external storage device of the hardware entity stores programs required for implementing the above-described functions, data required for processing of the programs, and the like (the programs may be stored, for example, in a ROM as a read-only storage device instead of the external storage device). Moreover, data or the like obtained by processing of these programs is appropriately stored in a RAM, an external storage device, or the like.

In the hardware entity, each program stored in the external storage device (or the ROM or the like) and data required for processing of each program are loaded into a memory as necessary, and are appropriately interpreted, executed, and processed by the CPU. As a result, the CPU implements predetermined functions (each of the components represented as . . . units or the like). That is, each component of an embodiment of the present invention may include processing circuitry.

As described above, in a case where the processing function in the hardware entity (each device described above) described in the description about the above embodiment is implemented by a computer, the processing content of the function that the hardware entity should have is described in a program. Then, as the computer executes the program, the processing function of the hardware entity is implemented on the computer.

The program in which the processing content is described can be recorded on a computer-readable recording medium. The computer-readable recording medium is, for example, a non-transitory recording medium, and is specifically a magnetic recording device, an optical disc, or the like.

Moreover, distribution of the program is performed by, for example, selling, transferring, or renting a portable recording medium such as a DVD or a CD-ROM in which the program is recorded. Furthermore, the program may be stored in a storage device of a server computer, and distributed by being transferred from the server computer to another computer via a network.

For example, a computer that executes such a program first temporarily stores the program recorded in a portable recording medium or the program transferred from a server computer in an auxiliary recording unit 1050 that is a non-transitory storage device of the computer itself. Then, at the time of executing processing, the computer loads the program stored in the auxiliary recording unit 1050 serving as the non-transitory storage device of the computer itself into the storage unit 1020 and executes processing according to the loaded program. Moreover, as another mode of executing the program, the computer may directly load the program from the portable recording medium into the storage unit 1020 and execute processing according to the program, or each time the program is transferred from the server computer to the computer, the computer may sequentially execute processing according to the received program. Moreover, the processing described above may be executed by a so-called application service provider (ASP) type service that implements a processing function only by an execution instruction and result acquisition without transferring the program from the server computer to the computer. Note that the program in this mode includes information that is to be used in processing by an electronic calculator and is equivalent to the program (data and the like that are not direct commands to the computer but have properties that define the processing to be performed by the computer).

Moreover, although the present device is configured by the predetermined program being executed on the computer in this mode, at least a part of the processing content may be implemented by hardware.

Additionally, it is needless to say that changes can be appropriately made without departing from the gist of this invention.

All documents, patent applications, and technical standards described in this specification are incorporated herein by reference to the same extent as in a case where incorporation by reference of each document, patent application, and technical standard is specifically and individually described.

1. A situation display device comprising
a display that displays a picture showing a situation of an object person in each partial time section, which is a time section included in a predetermined time section, in association with the partial time section, in a vicinity of a two-dimensional graph showing an utterance amount of the object person per unit time in the predetermined time section, with one person who is an object of situation display as the object person.

2. The situation display device according to claim 1,
wherein the utterance amount of the object person is obtained by performing voice recognition on a sound acquired by a microphone included in a mobile device, and a situation of the object person is obtained using at least sensor information acquired by one or more sensors other than the microphone included in the mobile device.

3. The situation display device according to claim 2,
wherein the one or more sensors include a position information sensor that acquires position information, the one or more sensors being included in the mobile device, and
a situation of the object person is obtained using at least sensor information acquired by the position information sensor.

4. The situation display device according to claim 1,
wherein pictures are selectable, and when any one of the pictures is selected, display is switched to a display of information regarding a situation and an utterance of the object person in a partial time section corresponding to selected picture.

5. The situation display device according to claim 1,
wherein the display also displays a ratio display graph that is a graph showing a ratio occupied by time during which the object person was in each situation, and
an area of each ratio included in the ratio display graph is selectable, and when any one of areas is selected, display is switched to a display of information regarding an utterance of the object person in a situation corresponding to selected area.

6. The situation display device according to claim 1,
wherein the display also displays a ratio display graph that is a graph showing a ratio occupied by time during which the object person was at each position, and
an area of each ratio included in the ratio display graph is selectable, and when any one of areas is selected, display is switched to a display of information regarding an utterance of the object person at a position corresponding to selected area.

7. A situation display method comprising
displaying, by a display, a picture showing a situation of an object person in each partial time section, which is a time section included in a predetermined time section, in association with the partial time section, in a vicinity of a two-dimensional graph showing an utterance amount of the object person per unit time in the predetermined time section, with one person who is an object of situation display as the object person.

8. A situation display device comprising
a display that displays a visual expression showing at least one of a situation, a state, or an action of an object person in each partial time section, which is a time section included in a predetermined time section, in association with the partial time section, in a vicinity of a visualized totalization result indicating a situation of human activity obtained from a voice of the object person per unit time in the predetermined time section, with one person who is an object of situation display as the object person.

9. The situation display device according to claim 8,
wherein the display also displays a ratio display graph that is a graph showing a ratio occupied by time during which the object person was in each situation, and
an area of each ratio included in the ratio display graph is selectable, and when any one of areas is selected, display is switched to a display of information regarding an utterance of the object person in a situation corresponding to selected area.

10. The situation display device according to claim 8,
wherein the display also displays a ratio display graph that is a graph showing a ratio occupied by time during which the object person was at each position, and
an area of each ratio included in the ratio display graph is selectable, and when any one of areas is selected, display is switched to a display of information regarding an utterance of the object person at a position corresponding to selected area.

11. A non-transitory computer readable medium storing instructions that, when executed by a processor, cause the processor to perform the method of claim 7.
